(19) United States
(12) Patent Application Publication
(10) Pub. No.: US 2015/0346502 A1
(43) Pub. Date: Dec. 3, 2015

(54) AUTOSTEREOSCOPIC THREE-DIMENSIONAL PROJECTOR AND METHOD OF DISPLAYING THEREOF

(71) Applicant: Electronics and Telecommunications Research Institute, Daejeon (KR)

(72) Inventors: Yang Su KIM, Daejeon (KR); Hyun LEE, Daejeon (KR); Eung Don LEE, Daejeon (KR); Jae Han KIM, Gwacheon-si Gyeonggi-do (KR); Gwang Soon LEE, Daejeon (KR); Namho HUR, Sejong-si (KR)

(21) Appl. No.: 14/722,954

(22) Filed: May 27, 2015

(30) Foreign Application Priority Data
May 30, 2014 (KR) 10-2014-0066481

(51) Int. Cl. G02B 27/22

(52) U.S. Cl. CPC G02B 27/2214

(57) ABSTRACT

An autostereoscopic three-dimensional projector includes a MicroElectroMechanical System (MEMS) processor, a virtual movable lens array, and a projection lens, the MEMS processor transfers each view image of the multiview image to a virtual movable lens array with different angles, the virtual movable lens array projects each of multiview images that are input with different angles to different locations of the projection lens, and the projection lens outputs the multiview image to a screen.

### CROSS-REFERENCE TO RELATED APPLICATION

This application claims priority to and the benefit of Korean Patent Application No. 10-2014-0066481 filed in the Korean Intellectual Property Office on May 30, 2014, the entire contents of which are incorporated herein by reference.

### BACKGROUND OF THE INVENTION

(a) Field of the Invention

The present invention relates to an autostereoscopic three-dimensional projector and a method of displaying thereof. More particularly, the present invention relates to an autostereoscopic three-dimensional projector that displays a three-dimensional image of a multiview method, and a method of displaying thereof.

(b) Description of the Related Art

A projector of an existing two-dimensional Digital Light Processing (DLP) method uses Cold Cathode Fluorescent Light (CCFL) or a Light Emitting Diode (LED) as a light source, and when an input image is input, a controller controls a color filter according to the input image to generate an image on each pixel basis, scans the image to correspond to a size of an input image in a digital micromirror device (DMD) module to generate an output image, transfers the output image to a projection lens, and outputs the output image from the projection lens to a screen.

A projector of a stereoscopic three-dimensional DLP method includes a sequential three-dimensional method and a side-by-side three-dimensional method. The sequential three-dimensional method transfers a left eye image to a projection lens at a time T and transfers a right eye image to a projection lens at a time 2T. The side-by-side three-dimensional method reduces an area of a left eye image and a right eye image by 50%, arranges the reduced left eye image and right eye image in a horizontal direction, and transfers the images to the projection lens.

The projector of the stereoscopic three-dimensional DLP method has a drawback in that it generates a different view image at the same location in the sequential three-dimensional method and deteriorates image quality when restoring a stereoscopic image in the side-by-side method.

### SUMMARY OF THE INVENTION

The present invention has been made in an effort to provide an autostereoscopic three-dimensional projector and a method of displaying thereof having advantages of being capable of projecting different view images to different locations without image quality degradation.

An exemplary embodiment of the present invention provides an autostereoscopic three-dimensional projector that displays a multiview image. The autostereoscopic three-dimensional projector includes a MicroElectroMechanical System (MEMS) processor, a virtual movable lens array, and a projection lens. The MEMS processor outputs each view image of the multiview image with different angles. The virtual movable lens array controls each view image so as to project each view image that is input with different angles by the MEMS processor to different locations. The projection lens outputs each view image that is projected to different locations by the virtual movable lens array to a screen.

The virtual movable lens array may separate the multiview image into a first group and a second group, alternately output a view image of the first group and a view image of the second group to different locations of the projection lens according to a predetermined time interval, and move a focus according to the predetermined time interval.

The predetermined time interval may be T, the virtual movable lens array may maintain an original focus at a time (2n−1)T and move a focus at a time 2nT, and the n may be an integer.

The first group may include an odd-numbered view image and the second group may include an even-numbered view image.

The MEMS processor may include a plurality of micro-mirrors, and the plurality of micro-mirrors may each be inclined by a predetermined angle.

Another embodiment of the present invention provides a method of displaying a multiview image in an autostereoscopic three-dimensional projector. The method includes: transferring, by a MicroElectroMechanical System (MEMS) processor, each view image of the multiview image to a virtual movable lens array with different angles; projecting, by the virtual movable lens array, each of multiview images that are input with different angles to different locations of a projection lens; and outputting, by the projection lens, the multiview image to a screen.

The projecting of each of multiview images may include: separating the multiview image into a first group and a second group; and alternately outputting a view image of the first group and a view image of the second group according to the predetermined time interval to the projection lens.

The predetermined time interval may be T, and the outputting of the multiview image may include: maintaining an original focus of the virtual movable lens array at a time (2n−1)T, when the predetermined time interval is T; and moving a focus of the virtual movable lens array at a time 2nT.

A focus moving distance of the virtual movable lens array may be determined according to a distance between view images of the first group or the second group.

### BRIEF DESCRIPTION OF THE DRAWINGS

FIG. 1 is a diagram illustrating an autostereoscopic three-dimensional projector according to an exemplary embodiment of the present invention.

FIG. 2 is a diagram illustrating an example of a view image that is output from a virtual movable active lens array of FIG. 1.

FIG. 3 is a flowchart illustrating a method of displaying an autostereoscopic three-dimensional projector according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements. Hereinafter, a three-dimensional projector and a method of displaying thereof according to an exemplary embodiment of the present invention will be described in detail with reference to the drawings.

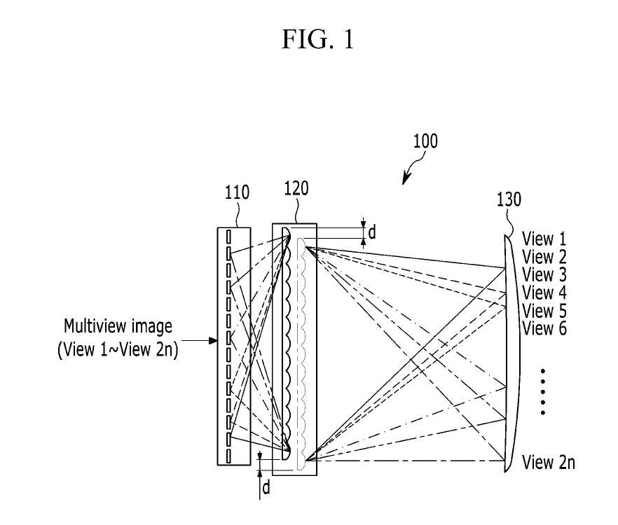

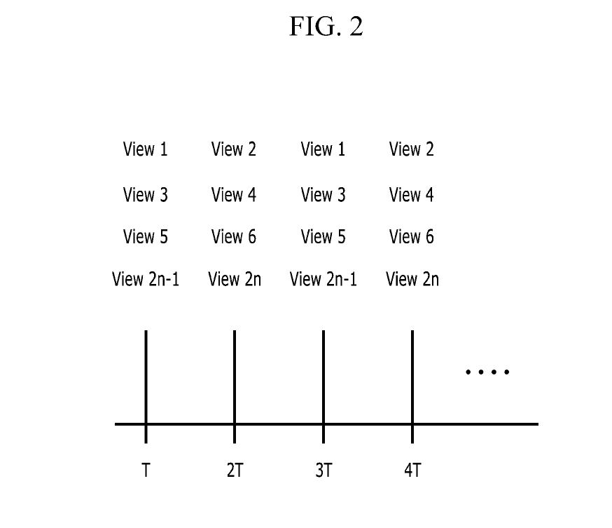

FIG. 1 is a diagram illustrating an autostereoscopic three-dimensional projector according to an exemplary embodiment of the present invention, and FIG. 2 is a diagram illustrating an example of a view image that is output from a virtual movable active lens array of FIG. 1.

Referring to FIG. 1, an autostereoscopic multiview three-dimensional projector 100 includes a MicroElectroMechanical System (MEMS) processor 110, a virtual movable lens array 120, and a projection lens 130.

The MEMS processor 110 includes a plurality of micro-mirrors, and each micro-mirror is minutely inclined with a predetermined angle. Therefore, when a multiview image is input to the MEMS processor 110, each view image is transferred to the virtual movable lens array 120 with different angles by each micro-mirror.

The virtual movable active lens array 120 transfers a plurality of view images to the projection lens 130 while changing a focus based on a constant time interval T. For convenience, FIG. 1 illustrates that the virtual movable active lens array 120 is moved, but actually, the virtual movable active lens array 120 is not physically moved and a focus of the virtual movable active lens array 120 is moved in a vertical direction.

Specifically, the virtual movable active lens array 120 maintains an original focus at a time (2n−1)T based on a constant time interval T and moves a focus by d at a time 2nT. Here, d is a horizontal moving distance of a focus in a plane of the virtual movable active lens array 120, and is a focus moving distance of a horizontal direction when converting a “distance/2 between odd-numbered view images in a plane of the projection lens 130” to a plane of the virtual movable active lens array 120.

The virtual movable lens array 120 separates a plurality of view images into two groups.

The virtual movable lens array 120 maintains an original focus and projects a view image of one group of two groups to the projection lens 130 at a time (2n−1)T, and changes a focus of the virtual movable lens array 120 by d and projects a view image of the remaining one group of the two groups to the projection lens 130 at a time 2nT. Here, n is an integer. For example, when two view images are input, the virtual movable lens array 120 maintains an original focus at a T time and moves a focus of an image of a first time point by d at a 2T time and outputs an image of a second time point, continuously outputs a first view image at a time (2n−1)T, and outputs a second view image at a time 2nT.

In this case, because an angle of each view image that is input to the virtual movable active lens array 120 is different, each of view images of one group is transferred to different locations of the projection lens 130 through the virtual movable lens array 120. Similarly, a view image of the remaining one group is also transferred to different locations of the projection lens 130 through the virtual movable lens array 120. Because a focus of the virtual movable active lens array 120 moves at a time 2nT, each of view images of two groups may be projected to different locations of the projection lens 130. For example, the virtual movable lens array 120 may separate a plurality of view images into an odd-numbered view image and an even-numbered view image. In this way, as shown in FIG. 2, at a time (2n−1)T, 1, 3, 5, . . . , 2n−1 view images corresponding to odd-numbered view images are output to the projection lens 130, and at a time 2nT, 2, 4, 6, . . . , 2n view images corresponding to even-numbered view images are output to the projection lens 130. Further, odd-numbered view images and even-numbered view images may be projected to different locations of the projection lens 130.

The virtual movable lens array 120 may separate a plurality of view images with different methods.

The projection lens 130 projects a multiview image that is transferred from the virtual movable active lens array 120 to the screen, thereby displaying a three-dimensional image.

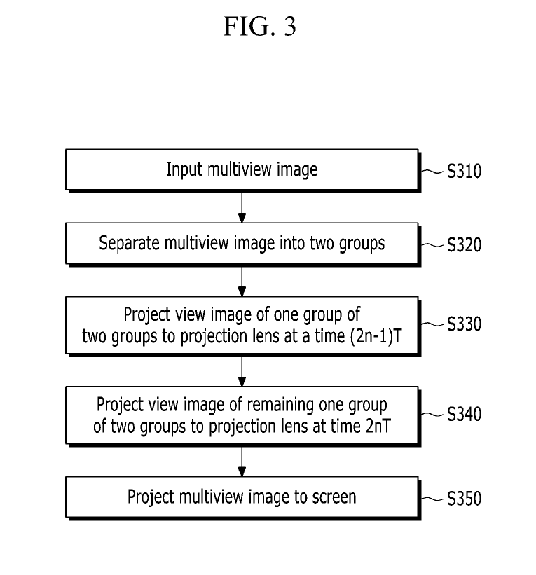

FIG. 3 is a flowchart illustrating a method of displaying an autostereoscopic three-dimensional projector according to an exemplary embodiment of the present invention.

Referring to FIG. 3, a multiview image is input to the autostereoscopic multiview three-dimensional projector 100 (S310).

The MEMS processor 110 of the multiview three-dimensional projector 100 transfers each view image to the virtual movable lens array 120 with different angles.

The virtual movable active lens array 120 separates a multiview image that is input with different angles into two groups (S320). The virtual movable lens array 120 projects a view image of one group of two groups to different locations of the projection lens 130 at a time (2n−1)T (S330) and projects a view image of the remaining one group of the two groups to a different location of the projection lens 130 at a time 2nT (S340).

Thereafter, the projection lens 130 projects a multiview image that is transferred from the virtual movable active lens array 120 to a screen, thereby displaying a three-dimensional image (S350).

In a conventional side-by-side three-dimensional method, one projector simultaneously projects a left eye image and a right eye image. Therefore, 50% of a projector resolution is used for a left eye image and 50% of the resolution is used for a right eye image, and thus degradation of resolution occurs. However, an autostereoscopic three-dimensional image projector according to an exemplary embodiment of the present invention projects a left eye image at a T time and a right eye image at a 2T time in a time division manner, thereby projecting both a left eye image and a right eye image with a resolution of the projector.

In this way, because the multiview three-dimensional projector 100 does not reduce an area of a left eye image and a right eye image by 50% like a side-by-side three-dimensional method, image quality degradation does not occur, and by using a virtual movable active lens array, when view images are different, the multiview three-dimensional projector 100 can project to different locations instead of the same location.

According to an exemplary embodiment of the present invention, when view images are different without image quality degradation using a virtual movable active lens, an autostereoscopic three-dimensional projector can project to different locations. Further, an autostereoscopic three-dimensional projector can be applied to an autostereoscopic super multiview stereoscopic image display.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An autostereoscopic three-dimensional projector that displays a multiview image, the autostereoscopic three-dimensional projector comprising:
a MicroElectroMechanical System (MEMS) processor that outputs each view image of the multiview image with different angles;
a virtual movable lens array that controls each view image so as to project each view image that is input with different angles by the MEMS processor to different locations; and
a projection lens that outputs each view image that is projected to different locations by the virtual movable lens array to a screen.

2. The autostereoscopic three-dimensional projector of claim 1, wherein the virtual movable lens array separates the multiview image into a first group and a second group and alternately outputs a view image of the first group and a view image of the second group to different locations of the projection lens according to a predetermined time interval, and
the virtual movable lens array moves a focus according to the predetermined time interval.

3. The autostereoscopic three-dimensional projector of claim 2, wherein the predetermined time interval is T,
the virtual movable lens array maintains an original focus at a time (2n−1)T and moves a focus at a time 2nT, and the n is an integer.

4. The autostereoscopic three-dimensional projector of claim 2, wherein the first group comprises an odd-numbered view image and the second group comprises an even-numbered view image.

5. The autostereoscopic three-dimensional projector of claim 1, wherein the MEMS processor comprises a plurality of micro-mirrors, and
the plurality of micro-mirrors are each inclined by a predetermined angle.

6. A method of displaying a multiview image in an autostereoscopic three-dimensional projector, the method comprising:
transferring, by a MicroElectroMechanical System (MEMS) processor, each view image of the multiview image to a virtual movable lens array with different angles;
projecting, by the virtual movable lens array, each of multiview images that are input with different angles to different locations of a projection lens; and
outputting, by the projection lens, the multiview image to a screen.

7. The method of claim 6, wherein the projecting of each of multiview images comprises:
separating the multiview image into a first group and a second group; and
alternately outputting a view image of the first group and a view image of the second group according to the predetermined time interval to the projection lens.

8. The method of claim 7, wherein the predetermined time interval is T, and
the outputting of the multiview image comprises:
maintaining an original focus of the virtual movable lens array at a time (2n−1)T, when the predetermined time interval is T; and
moving a focus of the virtual movable lens array at a time 2nT.

9. The method of claim 8, wherein a focus moving distance of the virtual movable lens array is determined according to a distance between view images of the first group or the second group.
